(19) United States
(12) Patent Application Publication
(10) Pub. No.: US 2004/0159985 A1
(43) Pub. Date: Aug. 19, 2004

(54) Method for making ceramic setter

(76) Inventors: Mark A. Altoonian, Morristown, TN (US); Gregory A. Akens, Morristown, TN (US); John R. Smelcer, Talbott, TN (US); Jason W. Darnell, Morristown, TN (US)

Correspondence Address: Eckert Seamans Cherin & Mellott,, LLC, Alcoa Technical Center, 100 Technical Center Drive, Alcoa Center, PA, 15069-0001, US

(21) Appl. No.: 10/369,316

(22) Filed: Feb. 18, 2003

(51) Int. Cl. C04B 33/32

(52) U.S. Cl. 264/649

(57) ABSTRACT

A method of making a ceramic setter comprises forming a mixture of ceramic particulates and a binder to a shape of a green ceramic setter. The green ceramic setter then is placed on a metallic support member such that air ingress is provided therebetween for allowing access of air to the surface of the setter adjacent the support member. The green setter on the support member is placed in a burn-out hood. A volatile constituent of the biinder is ignited to burn off excess volatile constituent. The air ingress allows ambient air to reach the bottom surface of the green setter adjacent to the support member as well as the top surface of the green setter such that the volatile constituent of the binder is ignited and burned at both the top and bottom surfaces of the green setter. Use of the support member in this manner results in a significant reduction in green setter contour distortion during the burn-out operation.

### FIELD OF THE INVENTION

The present invention relates to a method for making a ceramic setter used in manufacture of ceramic cores for the casting of molten metallic materials.

### BACKGROUND OF THE INVENTION

Most manufacturers of gas turbine engines are evaluating advanced investment cast turbine airfoils (i.e. turbine blade or vane) which include intricate air cooling channels to improve efficiency of airfoil internal cooling to permit greater engine thrust and provide satisfactory airfoil service life. Internal cooling passages are formed in the cast airfoils using one or more thin airfoil shaped ceramic cores positioned in a ceramic shell mold where the molten metal is cast in the mold about the core. After the molten metal solidifies, the mold and core are removed to leave a cast airfoil with one or more internal passages where the cores formerly resided.

The ceramic core is typically made using a plasticized ceramic compound comprising ceramic flour, binder and various additives. The ceramic compound is injection molded, transfer molded or poured at elevated temperature in a core die or mold. When the green (unfired) core is removed from the die or mold, it typically is placed on a rigid ceramic setter to cool to ambient temperature before core finishing and gauging operations and firing at an elevated sintering temperature. The green ceramic core is fired on the ceramic setter at elevated (superambient) temperature in one or more steps to sinter and strengthen the core for use in casting metallic material, such as a nickel base or cobalt base superalloy. U.S. Pat. No. 6,403,020 discloses a green ceramic core positioned on a rigid setter during firing. U.S. Pat. Nos. 5,014,763 and 6,347,660 disclose a green ceramic core positioned between top and bottom setters during firing.

The rigid setter is used during firing to maintain dimensional tolerances of the ceramic core since any setter contour distortion can adversely affect the dimensional tolerances achievable during firing of a ceramic core thereon. For example, setter contour distortion may result in the green ceramic core improperly contacting the ceramic setter such that dimensional variations from one ceramic core to the next occur in a production run.

### SUMMARY OF THE INVENTION

The present invention provides a method for making a ceramic setter used in manufacture of a ceramic core for use in the casting of molten metallic material. In an embodiment of the invention, a mixture of ceramic particulates and a binder is formed to a shape of a green ceramic setter. The green ceramic setter then is placed on a metallic support member, such as for example a support plate, so that air ingress means are provided to allow access of air to the surface of the setter adjacent the support member. A volatile constituent, such as, for example alcohol, of the binder of the green setter is ignited at exterior setter surfaces to burn off at least a portion of the volatile constituent in a manner that reduces surface crazing and increases the green strength of the ceramic setter. The air ingress allows ambient air to reach the bottom surface of the green setter adjacent to the support member as well as the top surface of the green setter such that the volatile constituent of the binder is at least partially burned off at both the top and bottom surfaces of the green setter to reduce surface crazing and increase the green strength of the ceramic setter. Use of the support member in this manner results in a significant reduction in green setter contour distortion during the flaming operation.

The above and other advantages of the present invention will become more readily apparent from the following detailed description taken with the following drawings.

### DESCRIPTION OF THE DRAWINGS

FIG. 1 is a perspective view of a ceramic setter disposed on a support plate having air ingress passages pursuant to an embodiment of the invention.

FIG. 2A is a plan or top view of the support plate showing air ingress holes extending through the thickness of the support plate.

FIG. 2B is an elevational view of the setter on the support plate showing air ingress holes extending through the thickness of the support plate.

FIG. 3A is a plan or top view of the support plate showing air ingress grooves in the surface of the support plate.

FIG. 3B is an elevational view of the setter on the support plate showing air ingress grooves in the surface of the support plate.

FIG. 4 is a cross-sectional view of ceramic setter on the support plate which is placed on a roller conveyor of a burn-out hood.

FIG. 5 is a cross-sectional view of a ceramic core disposed on a fired ceramic setter made pursuant to an embodiment of the invention.

### DESCRIPTION OF THE INVENTION

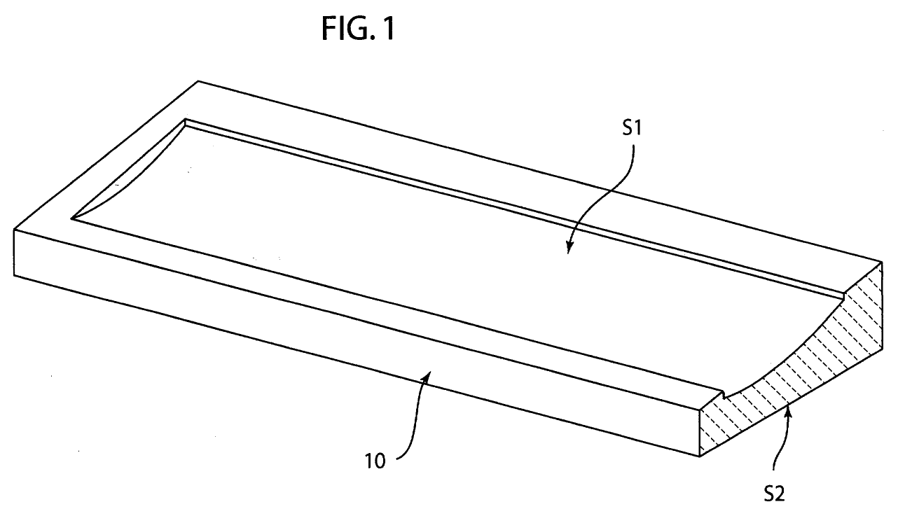

The present invention is described herebelow for purposes of illustration only with respect to manufacture of a ceramic setter 10, shown FIG. 1, made by conventional poured molding technique where a plasticized ceramic compound is introduced into a die or mold (not shown). The invention is not limited to ceramic setter made by the poured molding process and can be practiced for ceramic setters made by other processes including, but not limited to, injection molding and transfer molding. Conventional poured setter molding involves mixing one or more ceramic flours (e.g. alumina, silica, zircon, and/or zirconia flour), a liquid binder such as catalytically cured ethyl silicate liquid binder which contains a volatile alcohol constituent, and other additives, pouring the mixture in a mold or die having the shape of the ceramic setter, curing the mixture, and and then removing the green ceramic setter 10 from the mold or die.

The particular ceramic powders, binders and additives for making the ceramic setter 10 can be selected from conventional materials available and used to this end and form no part of this invention. For purposes of illustration and not limitation, the binder can comprise an organometallic binder such as hydrolyzed ethyl silicate containing a volatile alcohol, such as isopropanol. The catalyst for such a binder can comprise a basic catalyst, such as ammonium hydroxide or morpholine which crosslinks the hydrolyzed ethyl silicate to produce a gel structure that hardens in the mold or die to form a green ceramic setter therein.

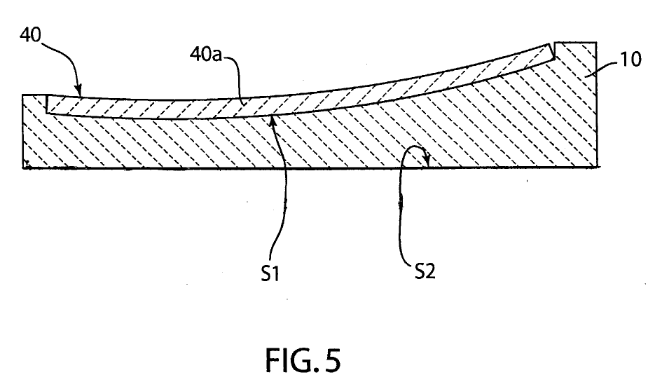

The green ceramic setter 10 includes an upwardly facing, contoured surface S1 and a flat bottom surface S2. The surface S1 has a preselected desired profile or contour complementary to a green ceramic core 40, FIG. 5, to be fired on the ceramic setter 10 as described below. For example, the setter surface S1 is shown having a preselected airfoil contour to receive an airfoil region 40a of the green ceramic core 40, FIG. 5. The setter surface S1 typically has a flat surface contour in that the surface does not include surface details, such as pedestals, turbulators, and the like, that may be present on the airfoil region 40a of the ceramic core 40.

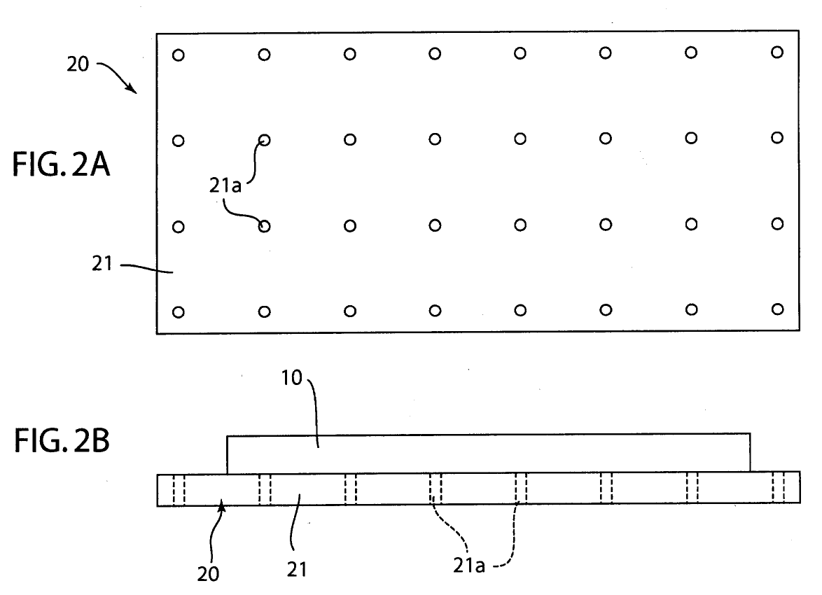

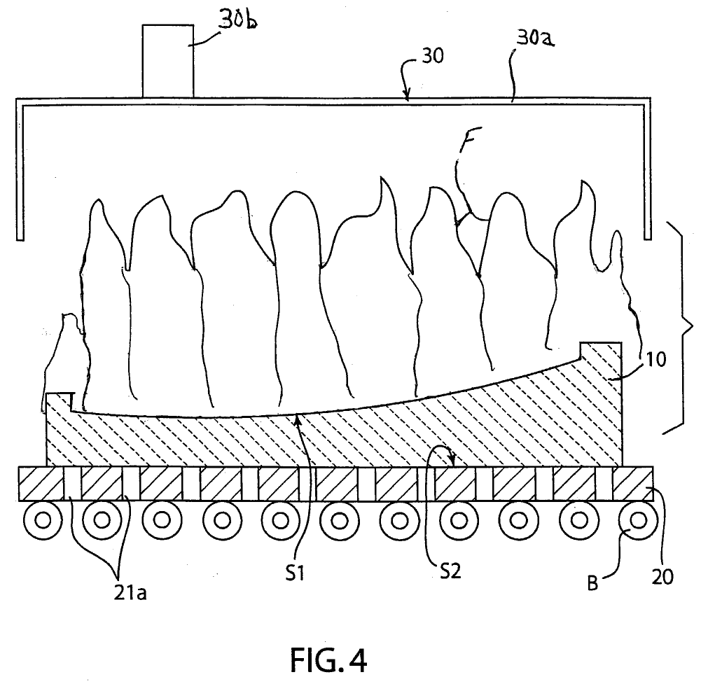

Pursuant to an embodiment of the invention, the green ceramic setter 10 then is placed on a support member 20, FIGS. 2A, 2B, shown for purposes of illustration and not limitation as a support plate 21 since the support member can comprise other than the plate shape shown. The green ceramic setter 10 can be positioned on the support member 20 following removal from the die or mold and typically after cooling to room temperature, although the invention is not so limited. In FIG. 2A, the support plate 21 is shown including a plurality of holes 21a extending through its thickness. For purposes of illustration and not limitation, the holes each can have a diameter as small as 0.5 inch and be spaced apart on a 2 or 6 inch center-to-center spacing. The holes 21a form air ingress means for allowing ambient air in a burn-out hood 30, FIG. 4, to reach and have access to the bottom surface S2 of the green ceramic setter 10.

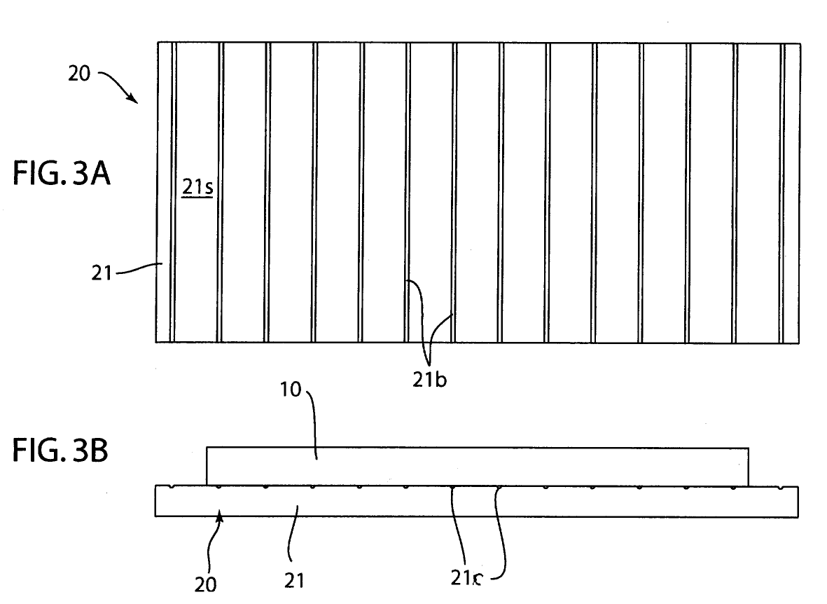

In FIGS. 3A, 3B, the support plate 21 is shown including a plurality of grooves 21b, rather than holes 21a, extending from edge-to-edge across its upper surface 21s on which the green ceramic setter will rest, although a single groove can be used if configured to provide access of air across the bottom surface S2 of the setter 10. For purposes of illustration and not limitation, the grooves each can have a width of 3/8 inch and be depth of 1/4 inch and be spaced 2 inches apart. The groove(s) 21b form(s) air ingress passage(s) 21c between the setter 10 and support plate 20 when the setter is placed on the support plate. The groove(s) 21b form(s) at least one air ingress means for allowing ambient air in a burn-out hood 30, FIG. 4, to reach and have access to the bottom surface S2 of the green ceramic setter 10. Alternately, in lieu of or in addition to providing holes 21a or grooves 21b on support member 20, the ceramic setter 10 can have a bottom surface S2 formed in the mold or die with one or more grooves or other surface features to form an air ingress passage between the setter 10 and support member 20 when the setter is placed thereon.

The support member 20 preferably comprises a stainless steel (e.g. Type 304L stainless steel) metallic plate 21 that is precision ground or otherwise machined to have at least the top surface thereof, which supports the green ceramic setter 10, with a precision flat profile, for example, having a total run out (difference between highest point to lowest point of top surface) of 0.020 inch or less. The support plate 21 can have any suitable dimensions, such as for purposes of illustration and not limitation, a width of 14 inches and a length of 30 inches. The thickness of the support plate 21 typically is in the range of 0.375 to 0.75 inch, although other plate thicknesses and dimensions can be used in practice of the invention. The support plate 21 can be made of materials other than metallic materials. These other materials include, but are not limited to, ground sintered ceramic materials.

The green ceramic setter 10 is placed on the support member 20 before being placed in a burn-out hood 30, FIG. 4. The volatile constituent of the binder is ignited at the exterior setter surfaces by placing an open-flame torch proximate the green setter after the setter 10 (on support member 20) is placed in the burn-out hood. The green ceramic setter 10 can be placed with its flat bottom surface S2 on the support member 20 as shown in FIG. 4. The burn-out hood comprises a conventional metal hood 30a including an exhaust duct 30b by which combustion products of the volatile constituent of the binder are exhausted to ambient atmosphere.

The support member 20 with the green ceramic setter 10 thereon is placed on roller conveyor B for movement into (and out of) the burnout hood 30. The volatile constituent of the binder is ignited by temporarily placing the open-flame torch adjacent an exterior setter surface after the setter 10 is placed in the burn-out hood so as to burn off a majority of the volatile alcohol of the binder for a time (e.g. 20 minutes) to reduce surface crazing and increase green strength of the green ceramic setter before being subjected to a high temperature firing treatment in a separate furnace. The air ingress means provided by holes 21a in FIG. 4 allows ambient air in the burn-out hood 30 to reach the bottom surface S2 of the green setter 10 resting on the support member as well as the free or uncovered top surface S1 of the green setter 10 in the burnout hood such that a majority of the volatile constituent of the binder is burned off at both the top and bottom surfaces S1, S2 of the green setter. Use of the support member 20 in the manner described results in a significant reduction in setter contour distortion during the flaming operation. This reduction in turn reduces dimensional variations of ceramic cores 40 fired on the ceramic setter 10, FIG. 5.

After the initial burn-out treatment in the burn-out hood 30 to burn off volatile constituent of the binder pursuant to the invention, the green ceramic setter 10 is placed on conventional kiln furniture and then is subjected to a high temperature firing operation that strengthens the ceramic setter 10 for subsequent use in making a ceramic core 40, FIG. 5, for casting metallic material. The green ceramic setter 10 can be fired in a conventional kiln to an elevated superambient firing temperature to sinter the ceramic core particles together and strengthen the setter. For firing a silica-based green ceramic setter, the maximum setter firing temperature can be in the range of 1600 to 2100 degrees F. for a time depending upon setter composition. For example only, for a silica setter, after the initial burn-out treatment, the setter can be sintered to 2100 degrees F. in a 24 hour cycle. Firing can be conducted in an air atmosphere in the kiln. The setter 10 typically is subjected to a conventional firing cycle involving a heat-up stage, hold-at-maximum firing temperature stage, and cool-down stage for an aggregate time period of several hours to several days. The heating rate to the maximum firing temperature typically is about 10 to about 150 degrees C. per hour for a silica-based setter for purposes of illustration only.

For purposes of illustration and not limitation, the fired ceramic setter 10 can be used in firing of a ceramic metal casting core 40, FIG. 5, that is used in the investment casting of a gas turbine airfoil, such as a turbine blade and vane. Such airfoils typically are investment cast using nickel base superalloys and cobalt base superalloys and are cast to have an equiaxed grain microstructure or directionally solidified microstructure comprising columnar grains or a single crystal. The ceramic core 40 forms one or more internal cooling passages in the airfoil as is well known.

FIG. 5 shows the green ceramic metal casting core 40 resting on the fired ceramic setter 10 ready for conventional firing of the ceramic core 40 to strengthen the core 40 for use in the casting of molten metallic material in a ceramic mold (not shown) in which the core 40 is positioned in conventional manner.

It will be apparent to those skilled in the art that variations can be made in the embodiments of the invention described without departing from the scope of the invention set forth in the claims.

We claim:

1. A method of making a ceramic setter, comprising the steps of forming a mixture comprising ceramic particulates and a binder to a shape of a green ceramic setter, placing said green ceramic setter on a support member such that air ingress means are provided for allowing access of air to a surface of said setter adjacent said support member, and igniting a volatile constituent of said binder of said ceramic setter while said setter resides on said support member.

2. The method of claim 1 wherein said support member includes said air ingress means.

3. The method of claim 2 wherein said air ingress means comprises a plurality holes through a thickness of said support member.

4. The method of claim 2 wherein said air ingress means comprises at least one groove on a surface of said support member that forms an air ingress passage when said green ceramic setter is placed on said surface of said support member.

5. The method of claim 1 wherein said support member comprises a metallic support plate.

6. The method of claim 1 wherein said setter includes a bottom flat surface that rests on said support member.

7. The method of claim 1 wherein said setter includes a top surface having an airfoil contour.

8. The method of claim 1 wherein said support member having said ceramic setter thereon is disposed in a burn-out hood to burn off the volatile constituent of said binder.

9. The method of claim 1 wherein said binder comprises hydrolyzed ethyl silicate.

10. The method of claim 9 wherein said mixture includes a basic catalyst which crosslinks said hydrolyzed ethyl silicate.
